(19) United States
(12) Patent Application Publication
(10) Pub. No.: US 2015/0153850 A1
(43) Pub. Date: Jun. 4, 2015

(54) ELECTRONIC DEVICE, DISPLAY CONTROL METHOD AND STORAGE MEDIUM

(71) Applicant: KABUSHIKI KAISHA TOSHIBA, Tokyo (JP)

(72) Inventors: Tetsuya Fujii, Fussa Tokyo (JP); Shigeru Motoi, Kokubunji Tokyo (JP)

(21) Appl. No.: 14/615,133

(22) Filed: Feb. 5, 2015

Related U.S. Application Data
(63) Continuation of application No. PCT/JP2013/057704, filed on Mar. 18, 2013.

(51) Int. Cl. G06F 3/0354; G06F 3/041

(52) U.S. Cl. CPC G06F 3/03545; G06F 3/041

(57) ABSTRACT

According to one embodiment, an electronic device includes a display and circuitry. The circuitry is configured to display a first object on the display. The first object corresponds to a first position where a touch input on the display is being detected. The circuitry is further configured to display a second object on the display. The second object corresponds to a locus of second positions where touch inputs on the display have been detected. The first object includes a moving portion extended in a direction from the first position toward the second object.

### CROSS REFERENCE TO RELATED APPLICATIONS

This application is a Continuation Application of PCT Application No. PCT/JP2013/057704, filed Mar. 18, 2013, the entire contents of which are incorporated herein by reference.

### FIELD

Embodiments described herein relate generally to an electronic device, a display control method and a storage medium.

### BACKGROUND

Recently, various types of portable electronic devices such as tablet computers and smartphones that can be driven by batteries have been developed. Most of the electronic devices of these types comprise touchscreen displays to facilitate an input operation performed by the user.

By touching a menu or an object displayed on the touchscreen display with a finger or the like, the user can instruct the electronic device to execute a function associated with the menu or object.

Input operations using the touchscreen display are used for not only giving the electronic device the instruction for operation, but also inputting a document by handwriting. Recently, users attend conferences and meetings while carrying the electronic devices of this type, and recorded notes by inputting the document on the touchscreen display by handwriting.

When the handwriting input is performed on the touchscreen display, the handwriting is displayed on the touchscreen display. Various types of proposals related to, for example, curve display, have been made.

Incidentally, when a character, a picture and the like are drawn on the touchscreen display with a pen (stylus) or a finger, input data is processed by software including an operating system (OS), and the character, a picture and the like are actually displayed on the touchscreen display with a delay of approximately several tens of milliseconds to 100 milliseconds. This delay is a reason for damaging handwriting feeling of the handwriting input on the touchscreen display.

Predicting a direction of extension and a magnitude (length) of a line segment from the handwriting is seen as a measure of the solution. However, it is needless to say that the prediction may be failed. If the prediction is failed, a predicted line does not match the handwriting, which has a risk of giving the user an uncomfortable feeling.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device of the embodiments.

FIG. 2 is an exemplary diagram showing a system configuration of the electronic device of the embodiments.

FIG. 3 is an exemplary functional block diagram of software relating to a handwriting input function operating on the electronic device of the embodiments.

FIG. 4 is an exemplary illustration for explanation of handwriting display delay.

FIG. 5 is an exemplary first illustration for explanation of a principle of display control processing performed by the electronic device of the embodiments.

FIG. 6 is an exemplary second illustration for explanation of a principle of display control processing performed by the electronic device of the embodiments.

FIG. 7 is an exemplary third illustration for explanation of a principle of display control processing performed by the electronic device of the embodiments.

FIG. 8 is an exemplary illustration for explanation of a first pattern of pen cursor display processing performed by the electronic device of the embodiments.

FIG. 9 is an exemplary illustration for explanation of a second pattern of pen cursor display processing performed by the electronic device of the embodiments.

FIG. 10 is an exemplary first illustration for explanation of a third pattern of pen cursor display processing performed by the electronic device of the embodiments.

FIG. 11 is an exemplary second illustration for explanation of the third pattern of pen cursor display processing performed by the electronic device of the embodiments.

FIG. 12 is an exemplary illustration showing an example of controlling gradation of a pen cursor line segment by the electronic device of the embodiments.

FIG. 13 is an exemplary flowchart showing a flow of pen cursor display control processing performed by the electronic device of the embodiments.

### DETAILED DESCRIPTION

Various embodiments will be described hereinafter with reference to the accompanying drawings.

In general, according to one embodiment, an electronic device comprises a display and circuitry. The circuitry is configured to display a first object on the display. The first object corresponds to a first position where a touch input on the display is being detected. The circuitry is further configured to display a second object on the display. The second object corresponds to a locus of second positions where touch inputs on the display have been detected. The first object comprises a moving portion extended in a direction from the first position toward the second object.

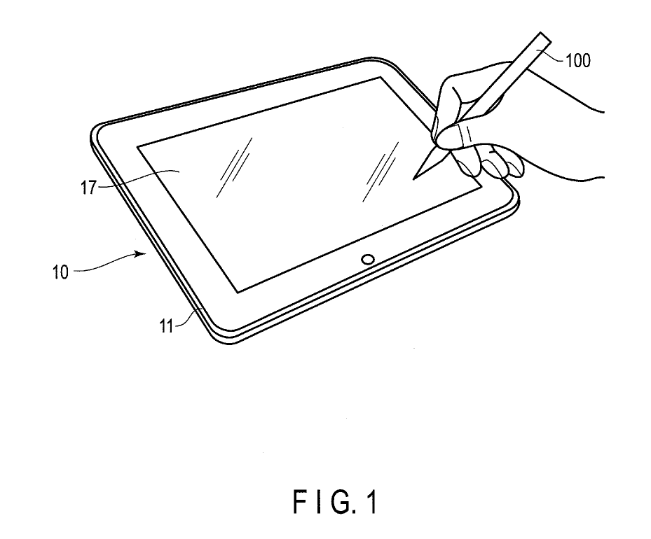

The electronic device of the embodiments can be implemented as a portable electronic device in which handwritten characters can be input by using a pen (stylus) or a finger, such as a tablet computer, a notebook-type personal computer and a smartphone. FIG. 1 is an exemplary perspective view showing an appearance of the electronic device of the embodiments. It is assumed that the electronic device is implemented as a tablet computer 10 as shown in FIG. 1. The tablet computer 10 comprises a main body 11 and a touchscreen display 17. The touchscreen display 17 is mounted to be overlaid on an upper surface of the main body 11.

The main body 11 comprises a housing shaped in a thin box. A flat panel display and a sensor configured to detect a contact position of a pen or a finger on a screen of the flat panel display are mounted in the touchscreen display 17. The flat panel display is, for example, a liquid crystal display (LCD). As the sensor, for example, an electrostatic capacitance type touch panel, an electromagnetic induction type digitizer, etc., can be employed. In the following explanations, it is assumed that both of two types of sensors, i.e., a digitizer and a touch panel, are mounted in the touchscreen display 17.

Each of the digitizer and the touch panel is provided to cover the screen of the flat panel display. The touchscreen display 17 can detect not only a touch input using the finger on the screen, but also a touch input using a pen 100 on the screen. The pen 100 may be, for example, an electromagnetic induction type pen. The user can perform a handwriting input on the touchscreen display 17 by using the pen 100 or finger. A handwriting input locus drawn by the pen 100 or finger (handwriting) is displayed on the screen.

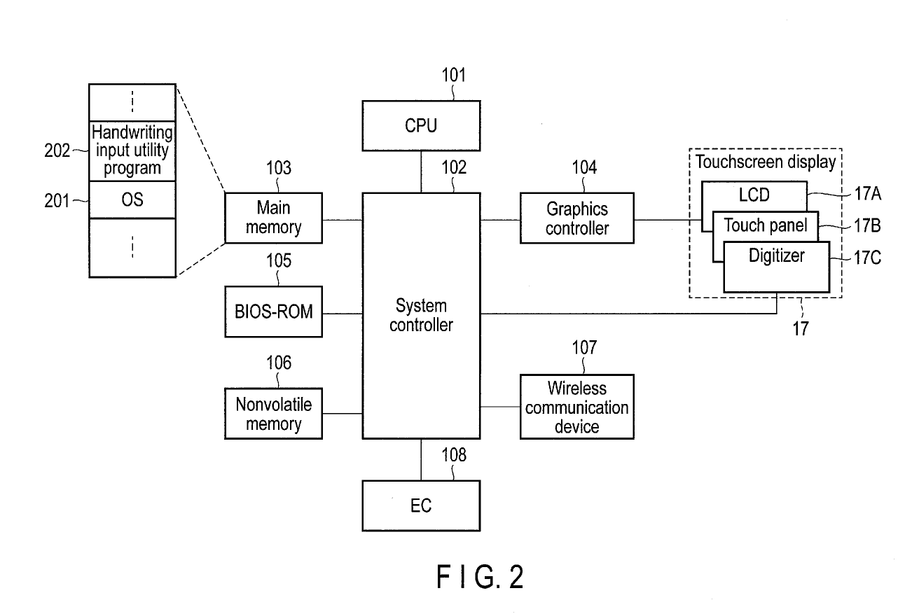

FIG. 2 is an exemplary diagram showing a system configuration of the tablet computer 10.

The tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc., as shown in FIG. 2.

The CPU 101 is a processor for controlling operations of various modules in the tablet computer 10. The processor includes circuitry. The CPU 101 performs various types of software loaded into the main memory 103 from the nonvolatile memory 106. The software includes an operating system (OS) 201 and a handwriting input utility program 202. A function of displaying the handwriting locus (handwriting) on the screen is provided by cooperation of the OS 201 and the handwriting input utility program 202.

In addition, the CPU 101 also performs a Basic Input/Output System (BIOS) stored in the BIOS-ROM 105. The BIOS is a program for hardware control.

The system controller 102 is a device which makes connection between a local bus of the CPU 101 and various components. A memory controller which controls access to the main memory 103 is also built in the system controller 102. In addition, the system controller 102 comprises a function of executing communication with the graphics controller 104 via a serial bus of PCI EXPRESS Standard.

The graphics controller 104 is a display controller which controls an LCD 17A employed as a display monitor of the tablet computer 10. A display signal generated by the graphics controller 104 is sent to the LCD 17A. The LCD 17A displays a screen image, based on the display signal. On the LCD 17A, a touch panel 17B and a digitizer 17C are arranged. The touch panel 17B is an electrostatic capacitance type pointing device for inputting data on the screen of the LCD 17A. A contact position of the finger on the screen is detected by the touch panel 17B. The digitizer 17C is an electromagnetic induction type pointing device for inputting data on the screen of the LCD 17A. A touch position of the pen 100 on the screen is detected by the digitizer 17C.

The wireless communication device 107 is a device configured to execute wireless communication such as wireless LAN or 3G mobile communication. The EC 108 is a single-chip microcomputer comprising an embedded controller for power management. The EC 108 comprises a function of powering on or powering off the tablet computer 10 in accordance with a user's operation on a power button.

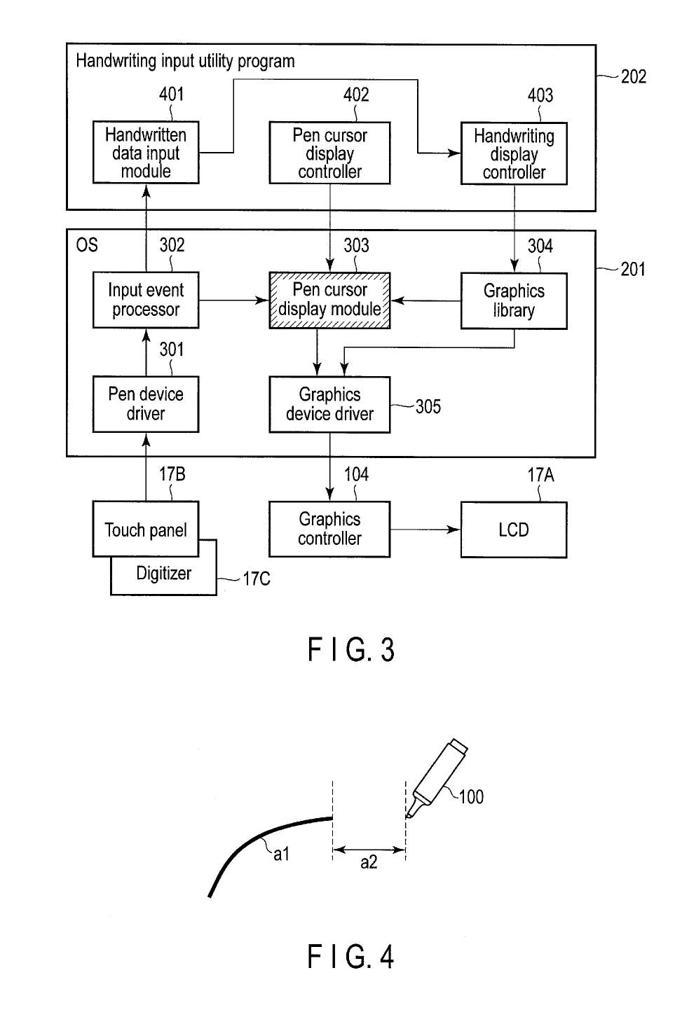

FIG. 3 is an exemplary functional block diagram of the software (OS 201 and handwriting input utility program 202) related to the handwriting input function that operates on the tablet computer 10.

The OS 201 comprises a pen device driver 301, an input event processor 302, a pen cursor display module 303, a graphics library 304 and a graphics device driver 305 as shown in FIG. 3. The handwriting input utility program 202 comprises a handwriting data input module 401, a pen cursor display controller 402 and a handwriting display controller 403.

As described above, the touchscreen display 17 detects a touch operation on the screen by the touch panel 17B or the digitizer 17C. A detection signal output from the touch panel 17B or the digitizer 17C is input to the pen device driver 301 of the OS 201, and supplied to the pen cursor display module 303 and the handwriting data input module 401 of the handwriting input utility program 202 through the input event processor 302. The detection signal includes coordinate information (X, Y).

The pen cursor display module 303 displays an object indicating a latest position where the touch operation is detected, on the LCD 17A, via the graphics device driver 305, based on the detection signal from the input event processor 302. The graphics device driver 305 is a module which controls the graphics controller 104 (which controls the LCD 17A). Here, this object is called a pen cursor. The user can confirm, for example, the touch input position of the pen 100, by the pen cursor. The pen cursor may be displayed only during the touch input of the pen 100 or may be continuously displayed after the touch input is finished.

In contrast, the detection signal supplied to the handwriting data input module 401 of the handwriting input utility program 202 is transferred to the handwriting display controller 403. The handwriting display controller 403 is a module which draws an object indicating the locus of handwriting input (handwriting), by using the graphics library 304 of the OS 201. This object is hereinafter simply called the handwriting. Any handwriting may correspond to the locus of the touch input position. The graphics library 304 displays the handwriting drawn by the handwriting display controller 403, on the LCD 17A, via the graphics device driver 305. The display position of the pen cursor may not necessarily match the display position of the handwriting.

The pen cursor display module 303 of the OS 201 comprises a function of controlling the shape of the pen cursor such that a display delay of the handwriting drawn by the handwriting display controller 403 of the handwriting input utility program 202 is inconspicuous. The pen cursor display controller 402 (of the hand input utility program 202) is a module which gives instructions for the operation of the function to the pen cursor display module 303 (of the OS 201). The function which the pen cursor display module 303 comprises will be hereinafter described.

To help understanding of the principle of the display control process performed by the tablet computer 10, handwriting display delay will be explained with reference to FIG. 4.

For example, when characters or pictures are drawn on the touchscreen display 17 by using the pen 100, the contact position of the pen 100 on the screen is detected by the digitizer 17C as described above. The digitizer 17C outputs a detection signal including coordinate information indicating the contact position to the system controller 102. The system controller 102 stores the detection signal received from the digitizer 17C in an own register and generates an interrupt signal for the CPU 101.

When the interrupt signal is generated, the detection signal is read from the register of the system controller 102 by the OS 201 (pen device driver 301) executed by the CPU 101 and input to the handwriting input utility program 202 (handwriting data input module 401) operating under the control of the OS 201. The handwriting input utility program 202 (handwriting display controller 403) draws handwriting of the handwriting input and displays the handwriting on the LCD 17A of the touchscreen display 17, based on the detection signal.

In FIG. 4, a1 indicates the handwriting of the handwriting input displayed on the LCD 17A of the touchscreen display 17. However, the pen 100 moves on the touchscreen display 17 during a period from the time when the contact position of the pen 100 on the screen is detected by the digitizer 17C to the time when, after the process mentioned above, the handwriting of the handwriting input is displayed on the LCD 17A of the touchscreen display 17 by the handwriting input utility program 202. Therefore, the handwriting is displayed with a delay from the position of the pen 100. In FIG. 4, a2 indicates a display delay section thus generated.

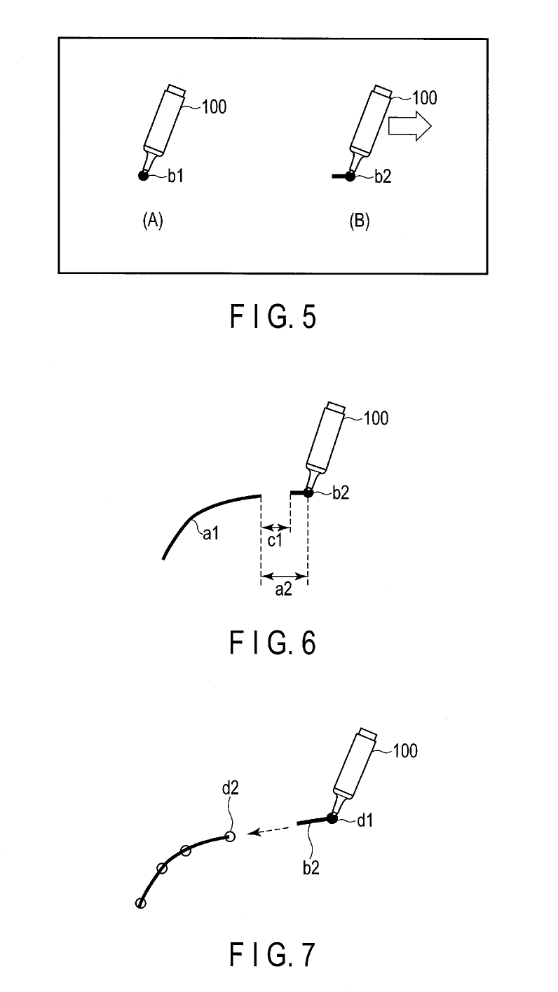

Considering this, the principle of the display control process executed by the tablet computer 10 will be explained with reference to FIG. 5, FIG. 6 and FIG. 7.

FIG. 5 is an exemplary illustration showing a shape of the pen cursor displayed on the LCD 17A by the pen cursor display module 303.

In FIG. 5, (A) shows the shape of a pen cursor (b1) formed when the pen 100, for example, contacts the surface of the touchscreen display 17. In contrast, (B) shows the shape of a pen cursor (b2) formed when the pen cursor display module 303 allows the function of controlling the shape of the pen cursor to perform and when the pen 100, for example, moves in a direction of an arrow on the touchscreen display 17. As shown in (B) of FIG. 5, the pen cursor b2 has a shape having a portion (line segment) extending opposite to the traveling direction of the pen 100. If the pen cursor display module 303 does not allow the function of controlling the shape of the pen cursor to perform, the pen cursor b1 shown in (A) of FIG. 5 is displayed even when the pen 100 moves.

It is assumed here that, in a situation where the pen cursor display module 303 allow the function of controlling the shape of the pen cursor to perform, the user executes describing using the pen 100 on the touchscreen display, similarly to the operation shown in FIG. 4 referred to for explanation of the handwriting display delay.

In this case, as described above, the pen cursor display module 303 displays the pen cursor b2 of the shape having a portion (a line segment in the example of FIG. 6) extending from the position where the touch input is detected by the pen 100 toward an end side of the handwriting, on the LCD 17A of the touchscreen display 17, as shown in FIG. 6. The display delay section of the handwriting becomes a section c1 in FIG. 6 and can be therefore shortened as compared with a2 in FIG. 4.

The portion extending from the position where the touch input is detected toward the end side of handwriting may be any portion that apparently shortens the display delay section of handwriting for the user. For example, the portion may be a line segment extending on the opposite side to the traveling direction of the pen 100, or a line segment connecting the position where the touch input is detected with the end side of handwriting, and is not limited to a line segment such as a straight line and a curve, but may have a shape corresponding to any other arbitrary picture icon.

Since shortening the display delay section of handwriting is implemented by controlling the shape of the pen cursor by the OS 201 (pen cursor display module 303), the short display delay section of handwriting is not influenced by the processing time for drawing the handwriting by the handwriting input utility program 202 (handwriting display controller 403), and then, does not affect the processing time for drawing the handwriting by the handwriting input utility program 202 (handwriting display controller 403).

Further, unlike a prediction line, the short display delay section of handwriting has no risk of giving the user abnormal feeling due to a mismatch between the actual handwriting and the predicted line in a case where prediction has failed.

It should be noted that a line segment extending to the opposite side of the traveling direction of the pen 100 of the pen cursor b2 is, more specifically, a line segment extending from a position (d1) indicated by the detection signal output from the touch panel 17B or the digitizer 17C toward an end (d2) of the handwriting drawn by the handwriting display controller 403 of the handwriting input utility program 202 as shown in FIG. 7. The pen cursor display module 303 acquires a position of the end (d2) of the handwriting from the graphics library 304.

Next, processing of displaying the pen cursor b2 in a shape extending to the opposite side of the traveling direction of the pen 100 by the pen cursor display module 303 of the OS201 will be explained.

(First Pattern)

First, a first pattern of processing of displaying the pen cursor b2 will be explained.

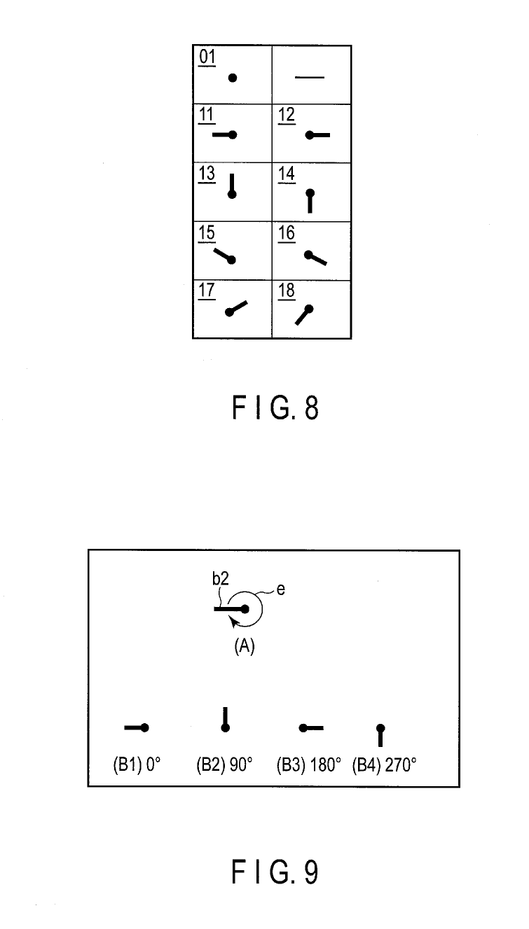

The pen cursor display module 303 preliminarily has image data for the pen cursor in a plurality of shapes as shown in FIG. 8. More specifically, the module 303 has the image data for the pen cursor b1 in the shape having no line segments, and the image data for eight pen cursors b2 in the shapes each having a line segment and, for example, extending directions of the line segments are made different by 45°.

The pen cursor display module 303 adaptively selects one of elements of the image data for the plurality of pen cursors b1 and b2 and displays the selected element of the image data on the LCD 17A, based on a positional relationship between the position indicated by the detection signal supplied from the input event processor 302 (i.e., output from the touch panel 17B or the digitizer 17C) and the position at the end of the handwriting acquired from the graphics library 304 (i.e., drawn by the handwriting display controller 403).

(Second Pattern)

Next, a second pattern of the processing of displaying the pen cursor b2 will be explained.

In the first pattern, the pen cursor display module 303 preliminarily has, for example, eight image data in the shapes in which the extending directions of the line segments are different by 45°. In the second pattern, the module has only one element of the image data for the pen cursor b2 in shape having a line segment (other than the image data for the pen cursor b1 in the shape having no line segments), and an angle (e) of rotation of the line segment is set and the line segment is displayed on the LCD 17A, as shown in, for example, FIG. 9.

In other words, the pen cursor display module 303 adaptively sets the rotation angle of the image data for the pen cursor b2 having the line segment and displays the line segment on the LCD 17A, based on the positional relationship between the position indicated by the detection signal supplied from the input event processor 302 (i.e., output from the touch panel 17B or the digitizer 17C) and the position at the end of the handwriting acquired from the graphics library 304 (i.e., drawn by the handwriting display controller 403). The extending direction of the line segment can be finely controlled by comparing with the first pattern.

(Third Pattern)

Next, a third pattern of the processing of displaying the pen cursor b2 will be explained.

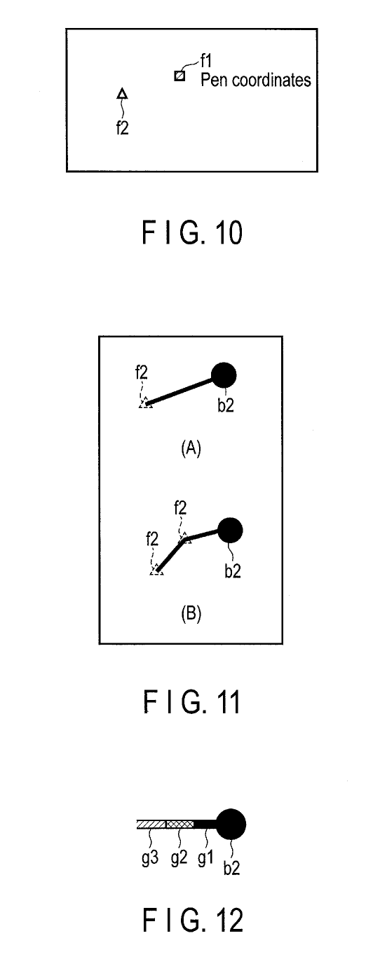

In the first and second patterns, the length of the line segment of the pen cursor b2 is fixed. In the third pattern, the pen cursor display module 303 sets at least one element of coordinate data (f2) including the end of the line segment of the pen cursor b2 and draws a line segment of the pen cursor b2 of variable length as shown in, for example, FIG. 10. In FIG. 10, f1 indicates a position indicated by the detection signal supplied from the input event processor 302 (i.e., output from the touch panel 17B or the digitizer 17C).

According to this method, the length of the line segment of the pen cursor b2 can be adjusted, based on, for example, the moving speed of the pen 100, i.e., a distance between the position indicated by the detection signal supplied from the input event processor 302 (i.e., output from the touch panel 17B or the digitizer 17C) and the position of the end of the handwriting acquired from the graphics library 304 (i.e., drawn by the handwriting display controller 403). In addition, a line segment can be drawn as a straight line as shown in (A) of FIG. 11 and, of course, a line segment can be drawn as a curve by setting a plurality of elements of coordinate data (f2) as shown in (B) of FIG. 11. When a line segment is drawn as a curve, the pen cursor display module 303 predicts handwriting continuing to the end of the handwriting which would lead to the position indicated by the detection signal supplied from the input event processor 302 (i.e., output from the touch panel 17B or digitizer 17C) from the previous handwriting position acquired from the graphics library 304 (i.e., drawn by the handwriting display controller 403), and sets a plurality of elements of coordinate data (f2) along the predicted handwriting.

For drawing a character or a picture on the touchscreen display 17 by using the pen 100, for example, the tablet computer 10 may be equipped with a user interface for appropriately setting a color or thickness. The pen cursor display module 303 of the OS 201 can control colors of the pen cursors b1 and b2 in accordance with user setting, in the first and second patterns. In the third pattern, the module 303 can also control the colors of the pen cursors b1 and b2, and the thickness of the line segment of the pen cursor b2 in accordance with user setting.

Furthermore, the pen cursor display module 303 of the OS 201 can control gradation of the line segment such that the pen cursor is paler toward a tip portion (g1 [dark]>g2>g3 [pale]) as shown in, for example, FIG. 12, in any of the first to third patterns.

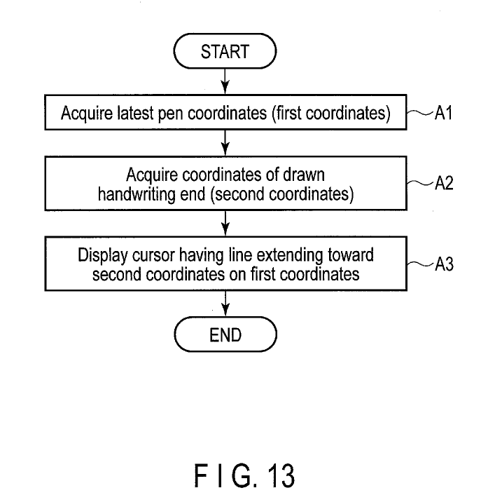

FIG. 13 is an exemplary flowchart showing a flow of pen cursor display control processing executed by the tablet computer 10.

The pen cursor display module 303 of the OS 201 acquires latest coordinates of the pen 100 from the input event processor 302 (block A1). In addition, the pen cursor display module 303 acquires from the graphics library 304 the coordinates of the end of the handwriting that has been drawn by the handwriting display controller 403 of the handwriting input utility program 202 (block A2). Then, the pen cursor display module 303 displays the pen cursor having the line segment extending toward the end side of the handwriting on the latest coordinates of the pen 100 (block A3).

As described above, according to the tablet computer 10, preventing the handwriting display delay from being conspicuous without giving an uncomfortable feeling to the user is implemented.

Since all the operation procedure of the embodiments can be implemented by software, the same advantage as that of the embodiments can easily be achieved by introducing the software on a normal computer through a computer-readable, non-transitory storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display; and
circuitry configured to:
display a first object on the display, the first object corresponding to a first position where a touch input on the display is being detected; and
display a second object on the display, the second object corresponding to a locus of second positions where touch inputs on the display have been detected,
wherein the first object comprises a moving portion extended in a direction from the first position toward the second object.

2. The device of claim 1, wherein the circuitry is configured to control a length of the moving portion in accordance with the first position and the second positions.

3. The device of claim 1, wherein:
the moving portion comprises a line; and
the circuitry is configured to control an attribute of the line in accordance with at least one of a type, thickness and a color of a line of the second object.

4. The device of claim 1, wherein the circuitry is configured to control gradation of the moving portion such that the moving portion becomes pale from the first position toward the second object.

5. The device of claim 1, wherein the circuitry is configured to predict a locus from the second object to the first position based on a second positions and the first position, and to control a shape of the moving portion to be a straight line or a curve extending along the predicted locus.

6. The device of claim 1, wherein the circuitry is configured to set one of a plurality of objects in shapes comprising portions extending in directions different from each other as the first object.

7. The device of claim 1, wherein:
the moving portion of the first object comprises a portion extending in a first direction; and
the circuitry is configured to set an angle at which the first object is rotated.

8. The device of claim 1, wherein the circuitry is configured to set at least one of coordinate data for drawing the moving portion including at least a coordinate data of an end of the moving portion.

9. A display control method of an electronic device, the method comprising:
displaying a first object on a display, the first object corresponding to a first position where a touch input on the display is being detected; and
displaying a second object on the display, the second object corresponding to a locus of second positions where touch inputs on the display have been detected,
wherein the first object comprises a moving portion extended in a direction from the first position toward the second object.

10. The method of claim 9, further comprising controlling a length of the moving portion in accordance with the first position and the second positions.

11. The method of claim 9, wherein the moving portion comprises a line, and
the method further comprising controlling an attribute of the line in accordance with at least one of a type, thickness and a color of a line of the second object.

12. The method of claim 9, further comprising controlling gradation of the moving portion such that the moving portion becomes pale from the first position toward the second object.

13. The method of claim 9, further comprising predicting a locus from the second object to the first position based on a second positions and the first position, and controlling a shape of the moving portion to be a straight line or a curve extending along the predicted locus.

14. The method of claim 9, further comprising setting one of a plurality of objects in shapes comprising portions extending in directions different from each other as the first object.

15. The method of claim 9, wherein the moving portion of the first object comprises a portion extending in a first direction, and the method further comprising setting an angle at which the first object is rotated.

16. The method of claim 9, further comprising setting at least one of coordinate data for drawing the moving portion including at least a coordinate data of an end of the moving portion.

17. A computer-readable, non-transitory storage medium having stored thereon a computer program which is executable by a computer, the computer program controlling the computer to execute functions of:
displaying a first object on a display, the first object corresponding to a first position where a touch input on the display is being detected; and
displaying a second object on the display, the second object corresponding to a locus of second positions where touch inputs on the display have been detected,
wherein the first object comprises a moving portion extended in a direction from the first position toward the second object.

18. The medium of claim 17, the computer program further controlling the computer to execute function of controlling a length of the moving portion in accordance with the first position and the second positions.

19. The medium of claim 17, wherein the moving portion comprises a line, and
the computer program further controlling the computer to execute function of controlling an attribute of the line in accordance with at least one of a type, thickness and a color of a line of the second object.

20. The medium of claim 17, the computer program further controlling the computer to execute function of controlling gradation of the moving portion such that the moving portion becomes pale from the first position toward the second object.

21. The medium of claim 17, the computer program further controlling the computer to execute function of predicting a locus from the second object to the first position based on a second positions and the first position, and controlling a shape of the moving portion to be a straight line or a curve extending along the predicted locus.

22. The medium of claim 17, the computer program further controlling the computer to execute function of setting one of a plurality of objects in shapes comprising portions extending in directions different from each other as the first object.

23. The medium of claim 17, wherein the moving portion of the first object comprises a portion extending in a first direction, and
the method further comprising setting an angle at which the first object is rotated.

24. The medium of claim 17, the computer program further controlling the computer to execute function of setting at least one of coordinate data for drawing the moving portion including at least a coordinate data of an end of the moving portion.
